(19) United States
(12) Patent Application Publication
(10) Pub. No.: US 2010/0171734 A1
(43) Pub. Date: Jul. 8, 2010

(54) System and Method for Extending Operating Time of an Electronic Device

(76) Inventor: Tsung-I Chiu, Tainan (TW)

Correspondence Address: STOUT, UXA, BUYAN & MULLINS LLP, 4 VENTURE, SUITE 300, IRVINE, CA, 92618, US

(21) Appl. No.: 12/350,613

(22) Filed: Jan. 8, 2009

(51) Int. Cl. G09G 5/00

(52) U.S. Cl. 345/212

(57) ABSTRACT

A system and method for extending operating time of an electronic device is disclosed. A battery power module provides power to a display module. A battery capacity detection module detects battery capacity of the battery power module. The pixels of the display module are then individually activated or deactivated according to the detected battery capacity.

### BACKGROUND OF THE INVENTION

1. Field of the Invention

The present invention generally relates to power management, and more particularly to a system and method for extending operating time of an electronic device whenever a low-battery status is detected.

2. Description of the Prior Art

The growing demands for portable or battery-powered electronic devices call for longer operating time. Battery power, however, simply cannot keep up with the pressing need of longer operating time for modern electronic devices with greater and more functionality. Rather than enhancing battery power, reducing power consumption is becoming an alternative and more feasible way to reach that goal.

When the battery of a portable electronic device, such as a notebook computer, is detected to be in a low-battery condition, a warning message is usually displayed, such that the user may instantly save anything important and then find a nearby alternating-current (AC) power source or install a backup battery. Unfortunately, as the nearby AC power or backup battery is often not available within a certain time or distance, the user commonly cannot do much other than wait for the battery to die.

For the reason that conventional portable or battery-powered electronic devices cannot assist users beyond just displaying the warning message, a need has arisen to propose a scheme that can substantially extend operating or run time of electronic devices when a low-battery status has been detected.

### SUMMARY OF THE INVENTION

In view of the foregoing, it is an object of the present invention to provide a system and method for automatically or manually extending operating time of portable or battery-operated electronic devices whenever a low-battery status is detected.

According to one embodiment, a battery power module provides power to a display module, and a battery capacity detection module detects battery capacity of the battery power module. The pixels of the display module are then individually activated or deactivated according to the detected battery capacity. Specifically, the detected battery capacity is compared with at least one predetermined threshold to determine a normal display mode when the battery capacity is greater than the threshold, and to determine at least a reduced display mode when the battery capacity is not greater than the threshold. In the normal display mode, a full display region is illuminated, and, in the reduced display mode, a reduced display region is illuminated.

### BRIEF DESCRIPTION OF THE DRAWINGS

FIG. 1A illustrates a system for extending operating time of an electronic device according to one embodiment of the present invention;

FIG. 1B illustrates the system for extending operating time of an electronic device according to another embodiment of the present invention;

FIG. 2 shows a flow diagram illustrating a method for extending the operating time of the electronic device according to the embodiments of the present invention;

FIG. 3 illustrates a functional diagram of a display with active lighting sources according to one embodiment of the present invention;

FIG. 4A shows an exemplary schematic display result in the normal display mode of FIG. 3;

FIG. 4B shows an exemplary schematic display result in the reduced display mode of FIG. 3;

FIG. 5 illustrates a functional diagram of a display with a backlight according to another embodiment of the present invention;

FIG. 6A shows an exemplary schematic display result in the normal display mode of FIG. 5; and

FIG. 6B shows an exemplary schematic display result in the reduced display mode of FIG. 5.

### DETAILED DESCRIPTION OF THE INVENTION

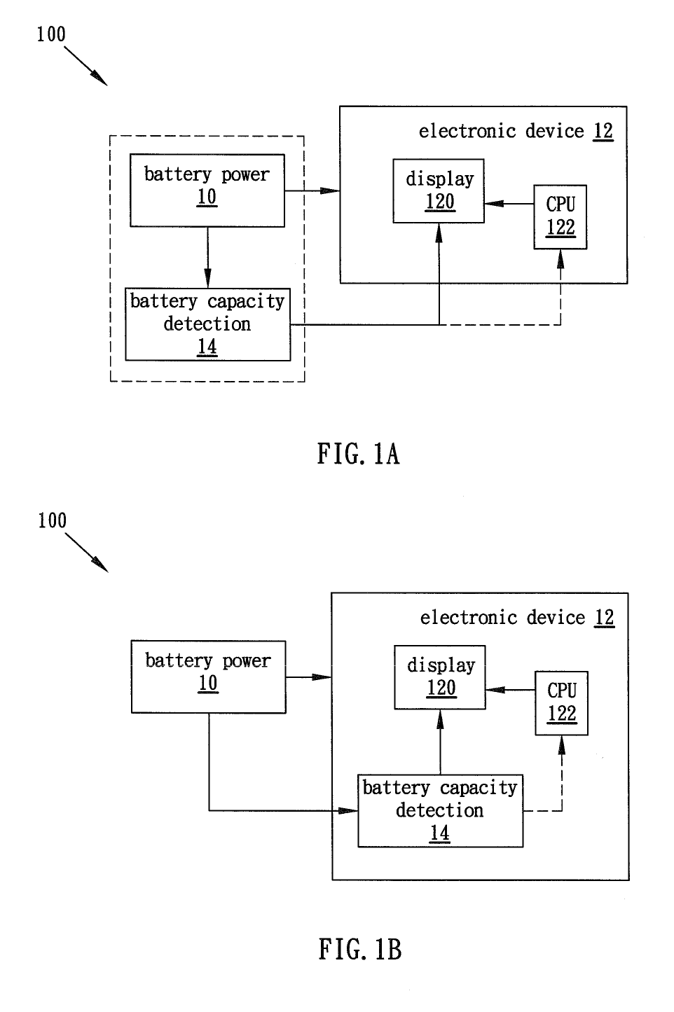

FIG. 1A illustrates a system 100 for extending operating time of an electronic device, particularly a direct-current (DC) powered or battery-operated portable electronic device, such as but not limited to, a notebook computer or mobile phone, according to one embodiment of the present invention. FIG. 1B illustrates the system 100 for extending operating time of an electronic device according to another embodiment of the present invention.

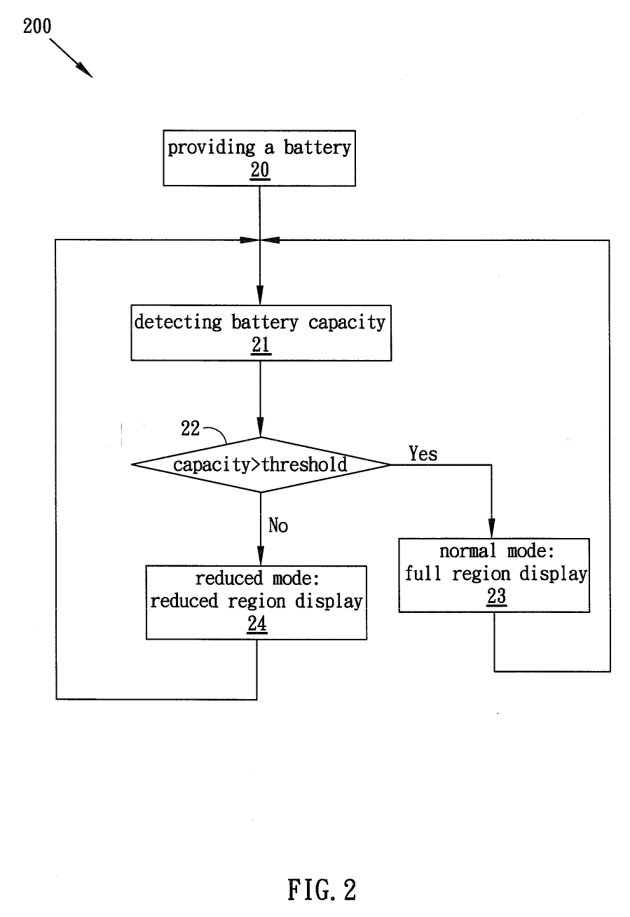

FIG. 2 shows a flow diagram 200 illustrating a method for extending the operating time of the electronic device according to the embodiments of the present invention. In the depicted embodiments, the system 100 includes a battery power module (“battery”) 10 that provides direct-current (DC) power to an electronic device 12 (step 20). The battery power module 10 may be a removable battery or an embedded battery of the electronic device 12. The battery power module 10 may include at least one primary battery, also known as a disposable battery, which is intended to be used once and discarded. Common types of disposable batteries are zinc-carbon batteries and alkaline batteries. The battery power module 10 may, alternatively, include at least one secondary battery, also known as a rechargeable battery, which must be charged before use. Common types of rechargeable batteries are nickel-cadmium (NiCd), nickel metal hydride (NiMH) and lithium-ion (Li-ion) batteries.

The system 100 also includes a battery capacity detection module 14 that detects the remaining battery capacity of the battery power module or the battery 10 (step 21). The term “capacity” is defined herein as the quantity of electricity that can be delivered by the battery 10. The capacity of the battery 10 may be detected based on discharge conditions such as one or more of the current magnitude (for example, in ampere-hours) or the terminal voltage (in volts) of the battery 10, and/or may be expressed in watt-hours that is equal to ampere-hours multiplied by the terminal voltage. For high-precision detection, the capacity may be determined based on alternative or further parameters, such as one or more of temperature or load.

With respect to the embodiment shown in FIG. 1A, the battery capacity detection module 14 and the battery 10 are combined to form a battery unit. The display 120 may be controlled by the battery capacity detection module 14, or by the central processing unit (CPU) 122, or both. With respect to the embodiment shown in FIG. 1B, the battery capacity detection module 14 is built inside the electronic device 12. The battery capacity detection module 14 may be implemented, for example, by a battery gauge integrated circuit (IC) that is specifically used to predict battery life of Li-ion powered applications.

The system 100 further includes a display module (“display”) 120 that forms a part of the electronic device 12. In exemplary embodiments, the display 120 may preferably be, but is not limited to, a light emitting diode (LED) based display panel in which active lighting sources, such as LEDs and/or OLEDs (organic light emitting diodes), display images without using backlighting. The display 120 may, alternatively, be a liquid crystal display (LCD) based display panel in which backlighting is needed to provide illumination, for example, by cold cathode fluorescent lamp (CCFL) or by LEDs.

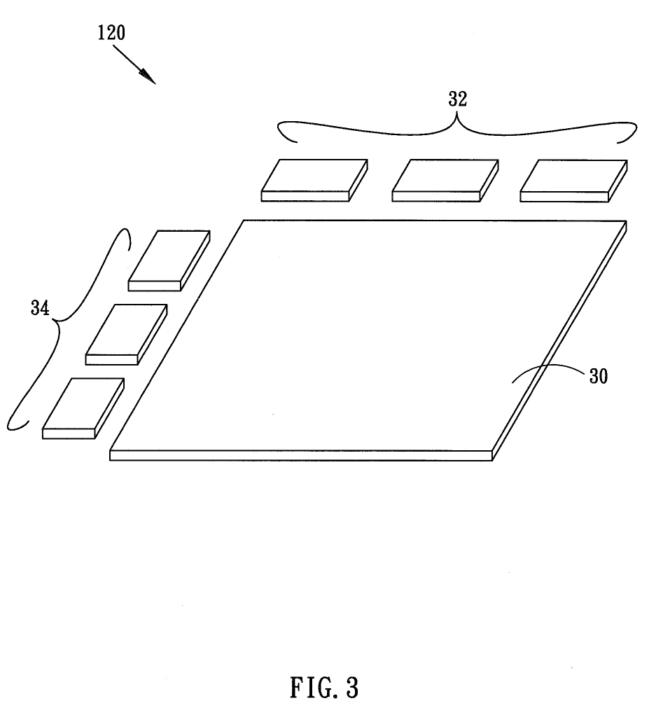

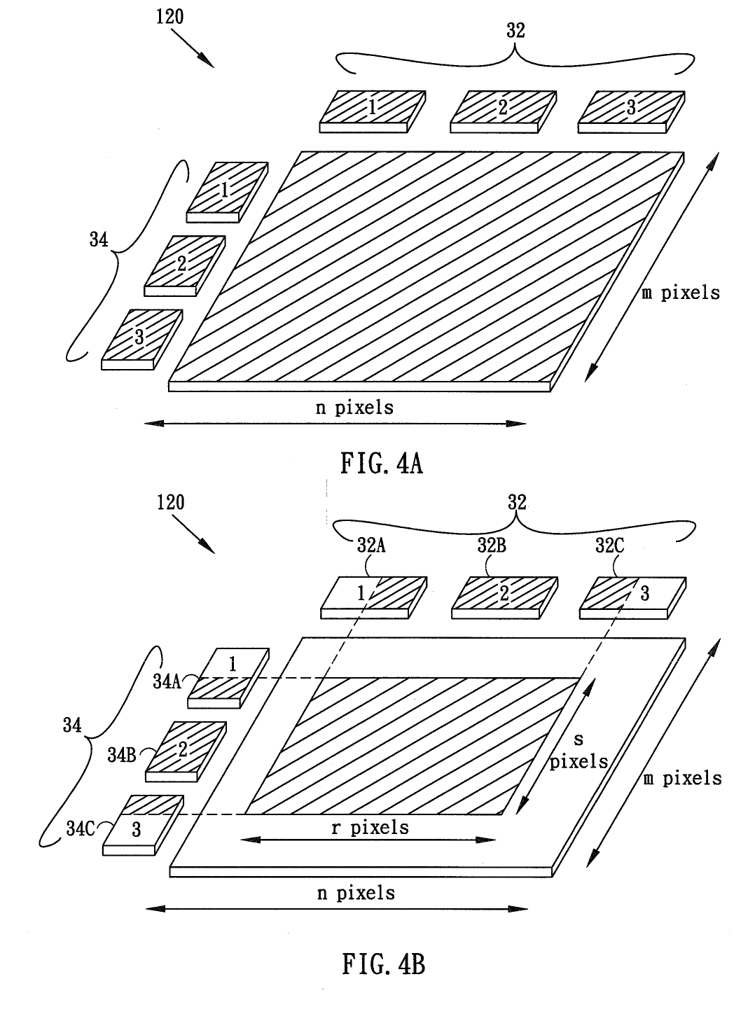

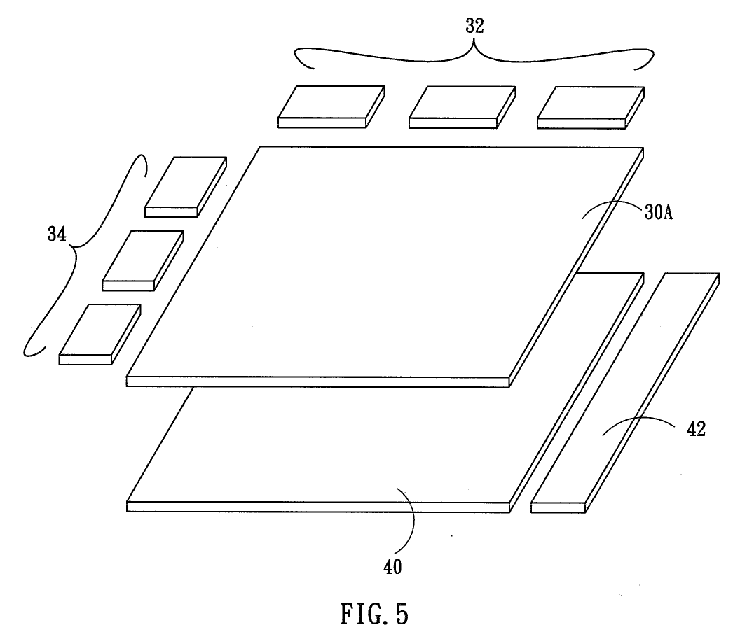

FIG. 3 illustrates a functional diagram of a display 120 with active lighting sources (e.g., LEDs and/or OLEDs) according to one embodiment of the present invention. The display 120 includes rows and columns of pixels (or picture elements) 30 arranged in matrix form. Along one side of the pixels 30 are data drivers 32, which provide analog image signals suitable for respectively controlling the intensity and/or color of the pixels and which are usually implemented by a number of data driving ICs (three ICs are figuratively shown in the figure). Along another side of the pixels 30 are scan drivers 34 that scan to enable each row of pixels in sequence and that are usually implemented by a number of scan driving ICs (three ICs are figuratively shown in the figure). As shown in FIGS. 1A-1B, the display 120 of the electronic device 12, directly or indirectly, receives detected battery capacity information from the battery capacity detection module 14. In the embodiments, the detected remaining capacity is compared with at least one predetermined threshold (step 22), by the battery capacity detection module 14 or the CPU 122 of the electronic device 12. In a case where the capacity is greater than the threshold, indicating that the battery 10 has sufficient power to be delivered, the display 120 displays a full display region (step 23). According to this case (i.e., the normal display mode), all of the data drivers 32 and/or the scan drivers 34 (e.g., typically 32 and 34) are asserted, and thus all of the pixels 30 of the full display region are activated or turned on. FIG. 4A shows an exemplary schematic display result in the normal display mode, in which n×m pixels, such as, for example, 1024×768 pixels (the Extended Graphics Array, XGA), are illuminated under control of all the data drivers 32 and/or the scan drivers 34 (that is, the shaded drivers in the figure).

Alternatively, in a case where the capacity is no longer greater than the threshold, indicating that the battery 10 has insufficient power to be delivered, the display 120 is switched, automatically or manually, to a reduced display mode corresponding to configuration of a reduced display region (step 24). The term “automatically” may mean that the CPU 122 of the electronic device 12 switches the display 12 into the reduced display mode with or without informing the user, while the term “manually” may mean that the CPU 122 switches the display 12 into the reduced display mode after the user has confirmed a request presented by the CPU 122. In the reduced display mode, only a portion of the data drivers 32 and/or the scan drivers 34 are asserted, and thus only the pixels 30 of a reduced display region are activated or turned on while other pixels are deactivated or turned off. FIG. 4B shows an exemplary schematic display result in the reduced display mode, in which r×s pixels, such as, for example, 800×600 (the Super Video Graphics Array, SVGA) pixels, are illuminated under control of a portion of the data drivers 32 and/or the scan drivers 34 (that is, the shaded drivers in the figure), while another portion of the pixels 30 is turned off as shown in the blank region.

It is appreciated that the lighting elements (e.g., LEDs and/or OLEDs) of the pixels 30 can be, in general, individually controlled. With respect to the exemplary display in FIG. 4B, a portion of the first data driver 32A is asserted (while the other portion is de-asserted), the whole second data driver 32B is asserted, and a portion of the third data driver 32C is asserted (while the other portion is de-asserted). In addition, a portion of the first scan driver 34A is asserted (while the other portion is de-asserted), the whole second scan driver 34B is asserted, and a portion of the third scan driver 34C is asserted (while the other portion is de-asserted). It is further noted that more than two threshold values may be used to determine the normal mode and/or more than one reduced mode. For example, in one embodiment that has one normal mode and two reduced modes (e.g., the first reduced mode and the second reduced mode), the portion of the asserted data drivers and/or the scan drivers in the first reduced mode is greater than that in the second reduced mode. For instance, 1024×768 pixels (XGA) can be displayed in the normal mode, 800×600 pixels (SVGA) can be displayed in the first reduced mode, and/or 640×480 pixels (Video Graphics Array, VGA) can be displayed in the second reduced mode.

According to the embodiment exemplified in FIG. 4A and FIG. 4B, in which each pixel is assumed to consume current of x μA, the full display region, thus, in the normal display mode (FIG. 4A), can be said to totally consume x*n*m μA. Taking 1024×768 pixels (XGA), for example, the full display region consumes 786432 μA, assuming each pixel consumes 1 μA. On the other hand, in the reduced display mode (FIG. 4B), the reduced display region can be determined to consume x*((n*m−r*s)) μA. Taking 800×600 pixels (SVGA) as an example, the reduced display region consumes 480000 μA. Accordingly, the display 120 consumes about 39% (i.e., (786432−480000)/786432) less, relative to the full-display mode power consumption, as a consequence of entering the reduced display mode. The preserved power can be used to substantially extend the operating or run time of the electronic device 12. During the extended period of time, the user is capable of completing more tasks before AC or backup battery power becomes available.

FIG. 5 illustrates a functional diagram of a display 120 with a backlight 40 according to another embodiment of the present invention. The backlight 40 may include CCFLs or LEDs, which are controlled by a backlight controller 42. The display 120 can be embodied as, for example, a LCD display panel 30A, which includes pixels of liquid crystal elements. Along one side of the display panel 30A are data drivers 32, and along another side of the display panel 30A are scan drivers 34.

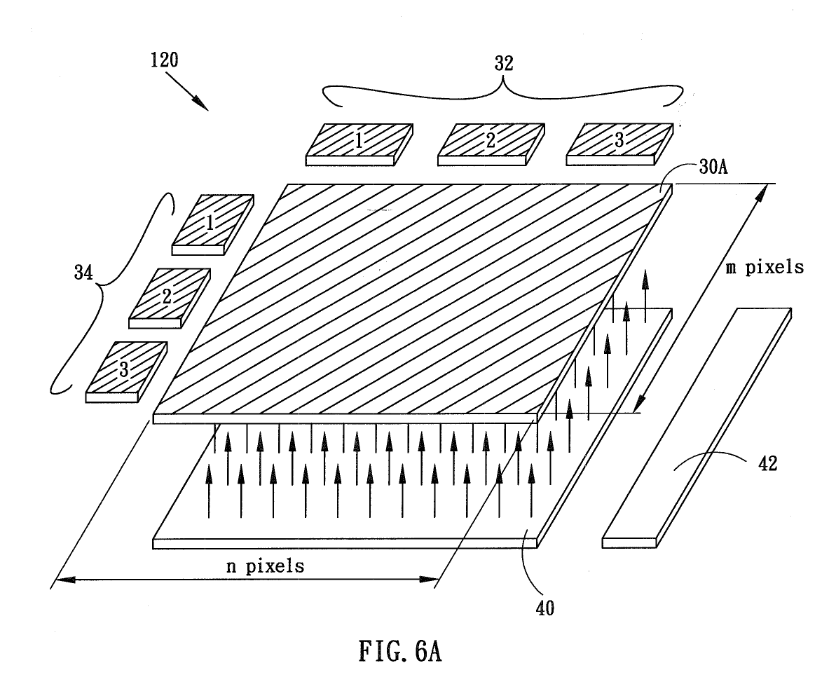

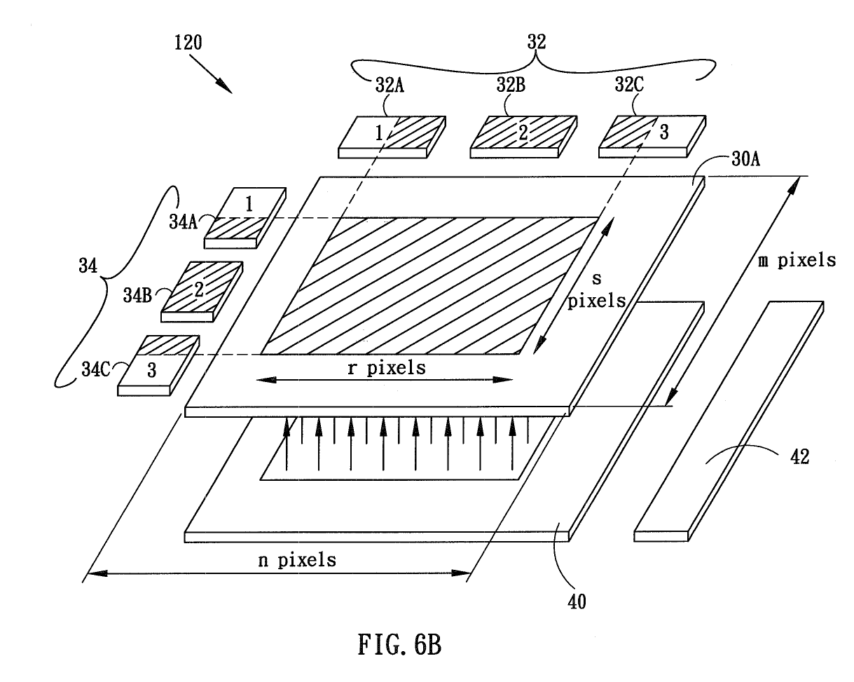

According to the exemplary embodiment, in the case where the capacity is greater than the threshold, indicating that the battery 10 has sufficient power to be delivered, the display 120 displays a full display region. For this case (i.e., the normal display mode), all of the data drivers 32 and/or the scan drivers 34 (e.g., typically 32 and 34) are asserted, and thus the full display region of the display panel 30A is activated or turned on. FIG. 6A shows an exemplary schematic display result for the normal display mode, in which n×m pixels, such as, for example, 1024×768 pixels (the Extended Graphics Array, XGA), are illuminated by the backlight 40 under control of all the data drivers 32 and/or the scan drivers 34 (that is, the shaded drivers in the figure). Moreover, the whole backlight 40, comprising for instance either a CCFL-based backlight or a LED-based backlight, is activated or turned on.

Alternatively, in the case where the capacity is no longer greater than the threshold, indicating that the battery 10 does not have sufficient power to be delivered, the display 120 is automatically or manually switched to a reduced display mode thus enabling only a reduced display region. In the reduced display mode, only a portion of the data drivers 32 and/or the scan drivers 34 are asserted, and thus only the corresponding pixels of the display panel 30A are activated or turned on with other pixels being deactivated or turned off. FIG. 6B shows an exemplary schematic display result in the reduced display mode, in which r×s pixels, such as, for example, 800×600 (the Super Video Graphics Array, SVGA) pixels, are illuminated by the backlight 40 under control of a portion of the data drivers 32 and/or the scan drivers 34 (that is, the shaded drivers in the figure), while another portion of the pixels of the display panel 30A are deactivated or turned off as shown in the blank region. Moreover, regarding the LED-based backlight, the LEDs corresponding to the deactivated pixels may be deactivated under control of the backlight controller 42. Alternatively, regarding the CCFL-based backlight, the CCFL or CCFLs corresponding to the deactivated pixels may optionally be deactivated under control of the backlight controller 42.

Although specific embodiments have been illustrated and described, it can be appreciated by those skilled in the art that various modifications may be made without departing from the scope and spirit of the present invention, which is intended to be limited solely by the appended claims.

What is claimed is:

1. A system for extending operating time of an electronic device, comprising:
a battery power module that provides power;
a battery capacity detection module that detects battery capacity of the battery power module; and
a display module that receives the power provided by the battery power module;
wherein the display module includes pixels that are individually activated or deactivated according to the detected battery capacity.

2. The system of claim 1, wherein the pixels are active lighting elements.

3. The system of claim 2, wherein the active lighting elements are one or more of LEDs and OLEDs.

4. The system of claim 1, wherein the pixels are liquid crystal elements.

5. The system of claim 1, wherein the battery capacity detection module detects the battery capacity based upon one or more of current magnitude and terminal voltage of the battery power module.

6. The system of claim 1, wherein the detected battery capacity is compared with at least one predetermined threshold to determine a normal display mode when the battery capacity is greater than the threshold, and to determine a reduced display mode when the battery capacity is not greater than the threshold.

7. The system of claim 6, wherein the display module includes:
at least one data driver that provides analog image signals suitable for respectively controlling one or more of intensity and color of the pixels; and
at least one scan driver that scans each row of the pixels in sequence.

8. The system of claim 7, wherein a full display region composed of all the pixels is illuminated in the normal display mode, and a reduced display region composed of a portion of the pixels is illuminated in the reduced display mode.

9. The system of claim 8, wherein all of the data driver and all of the scan driver are asserted to activate all of the pixels in the normal display mode, and a portion of the data driver and the scan driver is not asserted in the reduced display mode, thereby deactivating a portion of the pixels.

10. The system of claim 9, further comprising a backlight.

11. The system of claim 10, wherein the backlight comprises LEDs.

12. The system of claim 10, wherein a portion of the backlight is deactivated in the reduced display mode.

13. A method for extending operating time of an electronic device, comprising:
powering a display by a battery;
detecting battery capacity of the battery; and
individually activating or deactivating pixels of the display according to the detected battery capacity.

14. The method of claim 13, wherein the display includes a plurality of active lighting elements.

15. The method of claim 14, wherein the active lighting elements are one or more of LEDs and OLEDs.

16. The method of claim 13, wherein the display includes a LCD.

17. The method of claim 13, further comprising:
comparing the battery capacity with at least one predetermined threshold to determine a normal display mode when the battery capacity is greater than the threshold, and to determine a reduced display mode when the battery capacity is not greater than the threshold.

18. The method of claim 17, the display including a plurality of lighting elements, wherein a full display region composed of all the pixels is illuminated in the normal display mode, and a reduced display region composed of a portion of the lighting elements is illuminated in the reduced display mode.

19. The method of claim 18, wherein whole portions of a data driver and of a scan driver are asserted to activate all of the pixels in the normal display mode, and a portion of one or more of the data driver and the scan driver is not asserted in the reduced display mode, thereby deactivating a portion of the pixels.

20. The method of claim 19, wherein the display further comprising a backlight, and a portion of the backlight is deactivated in the reduced display mode.
